(19) United States
(12) Patent Application Publication
(10) Pub. No.: US 2004/0209012 A1
(43) Pub. Date: Oct. 21, 2004

(54) Ink-jet recording sheet with improved ozone resistance and light fastness

(76) Inventors: Richard A. Barcock, Aylesbury (GB); Aidan J. Lavery, Wendover (GB); Chris Cusick, Pulaski, NY (US)

Correspondence Address: AMSTER, ROTHSTEIN & EBENSTEIN, 90 PARK AVENUE, NEW YORK, NY, 10016

(21) Appl. No.: 10/785,290

(22) Filed: Feb. 23, 2004

(30) Foreign Application Priority Data
Mar. 6, 2003 (DE) 103 09 705.8

(51) Int. Cl. B41M 5/00

(52) U.S. Cl. 428/32.24

(57) ABSTRACT

An ink jet recording material comprising a support and at least one image recording layer has a protective layer on the upper side of the image recording layer, said protective layer containing an organic sulphur-containing compound which forms complexes with metal ions and a boric acid compound and wherein the image recording layer and/or the protective layer contains an organic compound having the formula MeX or MeX₂ where Me is a transition metal from group VIb, VIIb, VIIIb, Ib and IIb in the Periodic Table and X is an anion of a carboxylic acid having 4 to 12 carbon atoms; the recording material has improved ozone resistance and light fastness and a higher resistance to the so-called color gamut.

### PRIORITY CLAIM

This application claims the benefit of German Patent Application No. 103 09 705.8, filed Mar. 6, 2003, the content of which is hereby incorporated by reference into the subject application.

### TECHNICAL FIELD OF THE INVENTION

The invention relates to a recording material for the ink-jet recording method comprising a support, an image recording layer and a protective layer.

### BACKGROUND OF THE INVENTION

In the ink-jet printing method, tiny droplets of ink are applied to a recording material using various techniques already described on many occasions and are absorbed by said material. Various requirements are imposed on the recording material such a high color density of the printed dots, high ink absorption capacity, short drying time and sufficient smear resistance associated therewith, dye diffusion in the direction transverse to the printed dots not exceeding the required amount (bleed) as well as low ink coalescence and high water resistance. Further requirements, especially for photo-like printing are uniform printing gloss and surface gloss of the recording material.

As a result of the major progress in ink-jet technology with regard to the image quality and printing speed of the printers, the market for ink-jet color printers has grown enormously. It is predicted that over the next few years the area of digital photography, especially photo-quality inkjet materials, will see further substantial development. In order to achieve photographic image quality with ink-jet printing, one of the most important development tasks is to achieve a high image resistance. This is resulting in new developments both in image receiving materials and in dye-based inks.

Ink-jet recording materials can be divided into two classes, namely those with recording layers that swell in water, which contain binders such as gelatine or polyvinyl alcohol, and those with microporous layers.

Those with layers that swell in water have the advantage that they are glossy and have very high color densities after printing. They have a good ozone resistance since the swellable layers prevent the penetration of ozone into the material as barriers. However, the material has disadvantages with regard to image quality (bleed, ink coalescence) and drying time.

Microporous systems which can rapidly absorb the ink during printing as a result of the cavities in the deposited layer, possess an excellent image quality because of the good color fixing. They have a short drying time and no problems occur with the coalescence and bleed. However, the images produced using such microporous recording materials are not light-fast and react sensitively to the gases contained in the air, especially ozone. The gas can easily penetrate into the micropores of the recording layers and, possibly, assisted by the catalytic action of the pigments contained in the layers, attack the double bonds of the dyes. The reactivity towards ozone can be further intensified by humidity at elevated temperature.

Solutions to the problem proposed at the present time include laminating the printed image using a polyester film or using inks containing alkali metal additives and groups of ammonium or amino salts. These solutions certainly have positive aspects but they are not free from disadvantages. The disadvantages include, on the one hand, the increase in production costs caused by the lamination step and on the other hand the metal-containing compounds tend to cause significant color shift which are seen as color haze.

Sufficient ozone resistance and gas stability is achieved by adding reducing agents or ozone trappers such as sodium thiosulphate or sodium thiocyanate. However, the light fastness deteriorates significantly, especially for the magenta color range.

Known additives for improving light fastness such as UV absorbers, radical quenchers and antioxidants are added individually or as a mixture to the image recording layer or are deposited as a separate layer.

However, this can again have negative effects on the image recording layer and thus on the subsequent image.

UV absorbers such as benzotriazoles or benzophenones are generally insoluble in water and tend to reduce the gloss on the image areas. Falsifications of the color reproduction are also observed. Since many compounds have their own color, color changes on the white image areas can easily occur. Benzotriazole compounds generally cause a deterioration in the ozone resistance.

Radical quenchers certainly improve the light fastness but have a negative effect on the color reproduction. Antioxidants have only a limited influence on the ozone resistance and light fastness.

In accordance with JP 10-264501 the ozone resistance can be improved by using a thermoplastic resin containing a softener as the binder in the ink receiving layer. The ozone-protective effect is probably achieved by the fact that the pigment and the absorbed ink dyes are covered by resin.

Another possibility for improving the zone resistance is described in JP 08-164664. An inorganic pigment whose surface is modified with cycloamylose is used in the ink-receiving layer.

EP 0 524 635 A1 proposes a recording material which contains a combination of starch particles, an ethylene/vinyl acetate copolymer and a cationic dye-fixing agent in the ink-receiving layer.

Furthermore, in accordance with JP 2000-177235 an Mg thiocyanate is used in a porous aluminium-oxide-containing layer to improve light fastness and ozone resistance.

In EP 1 157 847 A1 the use of benzotriazole derivatives in the ink-receiving layer to improve the gas resistance of the recording material is described.

EP 1 029 703 A1 describes the use of hydroquinone, pyrocatechol sulphonic acid salts and phenol sulphonic acid salts to improve the light fastness. These substances can be deposited in a separate layer or added directly to the receiving layer. No improvement in the ozone resistance can be achieved with these compounds.

EP 1 138 514 A2 describes an ink-jet recording material in which the lower layers serve to improve the light fastness and can contain a divalent metal compound such as copper, aluminium and zinc. However, no improvement in the ozone resistance can be achieved with this recording material.

In JP2000-103160 a polyvalent metal ion such as copper, nickel, cobalt and/or zinc is added to the recording layer. This arrangement ensures good light fastness but has the disadvantage of incorrect color reproduction at parts of the image and poor ozone resistance.

DE 101 01 309 A1 describes an ink-jet recording sheet with an ink-receiving layer containing a sulphur compound and a cationic substance. This layer can also contain a metal compound. An additional protective layer for the zinc-receiving layer is not described.

In EP 0 614 771 A1 the yellowing in the edge area is improved by using organic acids with an aromatic ring or at least two carboxyl groups in the receiving layer. However, good light fastness and ozone resistance can only be established to a limited extent on the printed receiving material.

### SUMMARY OF THE INVENTION

The object of the invention is thus to provide another recording material for the ink-jet printing method which has improved resistance to the action of ozone and at the same time has a high light fastness. In particular a so-called color shift/color gamut should be reduced.

This object is solved by an ink-jet recording material having a support and at least one image recording layer, wherein on the upper side of the image recording layer there is arranged a protective layer containing an organic sulphur-containing compound which forms complexes with metal ions and a boric acid compound, and wherein the image recording layer and/or the protective layer contains an organic compound having the formula MeX or MeX₂ where Me is a transition metal from the fourth sub-group of the Periodic Table and X is a carboxylic acid anion having 4 to 12 carbon atoms.

According to another preferred embodiment, the image-recording layer can have two layers, namely an upper dye-fixing layer and a lower ink-absorbing layer. The dye-fixing layer is thus arranged between the protective layer and the ink-absorbing layer. In this embodiment the sulphur-containing compound and the boric acid compound are contained in the protective layer and the metal compound is contained in the dye-fixing layer.

It was surprisingly found that impairment of the color reproduction which is frequently observed when adding transition metal compounds, especially copper compounds, did not occur. This undesirable phenomenon of color shift, especially of the colors magenta and red, results in a cloudy image; the image lacks brilliancy. As a result of the formation of a complex of metal compound and sulphur-containing compounds in the presence of boric acid, a good light fastness and a very good ozone resistance can be achieved with this layer.

### DETAILED DESCRIPTION OF THE INVENTION

Suitable metal compounds according to the invention can be those of a transition metal from group VIb, VIIb, VIIIb, Ib and IIb of the Periodic Table of Elements. Preferably copper, cobalt, nickel or manganese can be contained as metal ions. Copper is especially preferred. Suitable metal compounds are organic metal compounds.

Suitable anions are anions of carboxylic acids having 4 to 12 carbon atoms. Especially preferred carboxylic acids are hydroxycarboxylic acids having 4 to 12 carbon atoms. Preferred hydroxycarboxylic acids include gluconic acid, glucaric acid, succinic acid, hydroxysuccinic acid (malic acid), 2,3-dihydroxysuccinic acid (tartaric acid) and their mixtures. Other preferred hydroxycarboxylic acids are aromatic hydroxycarboxylic acids such as hydroxybenzoic acid, for example, 2-hydroxybenzoic acid (salicylic acid), 3-hydroxybenzoic acid, 4-hydroxybenzoic acid, 2,4,5-trihydroxybenzoic acid, 4- or 5-sulphosalicylic acid, 4- or 5-hydroxythiosalicylic acid and their mixtures.

Finally the suitable carboxylic acids comprise complex-forming agents such as the anions of ethylene diamine tetracetic acid (EDTA), ethylene diamine triacetic acid, hydroxyethyl ethylene diamine tetracetic acid (HEEDTA) and nitrolo triacetic acid. These can also be used in mixtures with one another or with hydroxycarboxylic acids.

The metal compound can be present in the protective layer or in the image recording layer in a concentration of 1 to 20 wt. %, preferably 4 to 15 wt. %, relative to the weight of the dried layer.

The complex-forming organic sulphur compound according to the invention is a compound having the general formula R₂C═S, wherein R equally or independently of one another is an NH₂ group, an NR¹₂ group, a methyl, ethyl, propyl, isopropyl group, a substituted or non-substituted aryl with 5 to 12 carbon atoms or alkoxy, especially methoxy or ethoxy, or both groups R form an aromatic or non-aromatic ring with 5 or 6 carbon atoms. This ring can contain nitrogen as a heteroatom. R¹ can equally or independently of one another have the same meaning as R and preferably denotes hydrogen, methyl or ethyl. Thiourea is preferably used.

According to another preferred embodiment, the complex-forming organic sulphur-containing compound is a compound having the general formula:

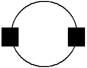

wherein Y denotes the atoms required to form a substituted or non-substituted aromatic or non-aromatic ring.

According to another preferred embodiment, the complex-forming organic sulphur-containing compound is a compound having the general formula R₂S, wherein R equally or independently of one another denotes hydrogen, alkyl with 1 to 6 carbon atoms, substituted or non-substituted aryl with 5 to 12 carbon atoms, an NH₂ group, an NR¹₂ group, an NH₂ group, an NR¹₂ group, OR¹, wherein R¹ equally or independently of one another can have the same meaning as R and is preferably hydrogen, methyl, ethyl, methoxy or ethoxy or an aryl group with 5 or 6 carbon atoms.

The sulphur compound can be present in the protective layer in a concentration of 30 to 80 wt. %, preferably 40 to 70 wt. %, relative to the weight of the dried layer.

The metal compound/sulphur compound quantitative ratio can be 1:1 to 1:6, preferably 1:1 to 1:2.

The boric acid compound can occur as boric acid or as an alkali metal or alkaline earth metal salt of a boric acid. The boric acid can be an orthoboric acid, a metaboric acid or a polyboric acid. It can be contained in the protective layer in a concentration of 20 to 80 wt. %, preferably 30 to 70 wt. %, relative to the weight of the dried layer.

In a preferred embodiment the layer contains a hydroxyaryl sulphonic acid in addition to the metal compound. According to an especially preferred embodiment this is a hydroxybenzoic sulphonic acid, for example, 4-hydroxybenzoic sulphonic acid or a sulphosalicylic acid hydrate, for example, 5-sulphosalicylic acid dihydrate. The hydroxyaryl sulphonic acid is a water-soluble compound. The hydroxyaryl sulphonic acid can be contained in the layer in a concentration of 1 to 20 wt. %, preferably 4 to 15 wt. %, relative to the weight of the dried layer.

The coating weight of the dried protective layer is 0.1 to 6.0 g/m², preferably 0.3 to 4.5 g/m².

The compounds according to the invention can be coated as a mixture or successively in separate solutions. In this case, one solution contains the metal compound and if necessary, the hydroxyaryl sulphonic acid, the other solution contains the sulphur-containing compound and the boric acid compound.

The protective layer can also contain binders, cross-linking agents, tensides, defoamers and light-stabilising agents. Especially water-soluble and/or water-dispersible polymers having a glass transition temperature T_{g} of 30 to 85° C. (DSC) and a viscosity of at most 60 cps (measured for a 4% solution at 20° C.) can be used as binders. Such polymers are, for example, polyurethane, polyacrylate, polyvinyl alcohols, gelatine, gelatine derivatives, cellulose, starches, modified starches, and/or polyvinyl acetate. Especially preferred as binders are polyurethane, polyacrylate and polyvinyl alcohols. The coating weight of the layer can be up to 10 g/m², especially up to about 8 g/m².

The image recording layer can be pigment-free or it can contain pigments. Suitable pigments for the image recording layer according to the invention are, for example, aluminium oxide, aluminium hydroxide, aluminium oxide hydrate, silica, barium sulphate and titanium dioxide. The use of aluminium oxides is preferred. The pigment concentration in the image recording layer can be 10 to 95 wt. %, preferably either 15 to 50 wt. % or 70 to 90 wt. %, relative to the weight of the dried layer.

The grain size distribution of the pigments of the image-recording layer can preferably be 50 to 500 nm, especially preferably 80 to 400 nm. The average particle size of the pigment of this layer can preferably be 80 to 120 nm, especially preferably about 100 nm.

The image recording layer contains a water-soluble and/or water dispersible polymer binder. Suitable binders are, for example, polyvinyl alcohol, completely or partly saponified, cationically modified polyvinyl alcohol, polyvinyl alcohol having silyl groups, polyvinyl alcohol having acetal groups, gelatine, polyvinyl pyrrolidone, starch, carboxymethyl cellulose, polyethylene glycol, styrene/butadiene latex and styrene/acrylate latex. Especially preferred are partly saponified polyvinyl alcohols. The quantity of binder can be 90 to 5 wt. %, preferably either 85 to 50 wt. % or 30 to 10 wt. %, relative to the weight of the dried layer.

The image recording layer can contain the usual additives and adjuvants such as tensides, cross-linking agents and dye-fixing agents such as polyammonium compounds. The coating weight of the image recording layer can be 5 to 60 g/m², preferably 10 to 50 g/m², especially preferably 20 to 40 g/m².

In another embodiment of the invention the image recording layer can be constructed of an ink-absorbing lower layer and a dye-fixing upper layer.

Suitable pigments for the ink-absorbing lower layer according to the invention are, for example, aluminium oxide, aluminium hydroxide, aluminium oxide hydrate, silica, barium sulphate and titanium dioxide. In the lower layer a pigment based on amorphous silica is especially preferable. Such a pigment can be cationically modified. The pigment concentration in the ink-absorbing layer is 65 to 95 wt. %, preferably about 70 to 90 wt. %, relative to the weight of the dried layer.

The grain size distribution of the pigment of the ink-absorbing layer can preferably be in the range of 100 to 1000 nm, preferably 130 to 400 nm, especially preferably 150 to 350 nm. The average particle size of the pigment of the ink-absorbing layer can be 240 to 350 nm, preferably 270 to 330 nm.

Suitable pigments for the dye-fixing layer according to the invention are, for example, aluminium oxide, aluminium hydroxide, aluminium oxide hydrate, silica, barium sulphate and titanium dioxide. The pigment concentration in the dye-fixing layer can be 70 to 95 wt. %, preferably 80 to 90 wt. %.

The grain size distribution of the pigment for the dye-fixing layer can preferably be in the range of 50 to 200 nm, preferably 80 to 120 nm. The average particle size of the pigment of the dye-fixing layer can preferably be 80 to 120 nm, preferably about 100 nm.

The ink-absorbing and the dye-fixing layers contain a water-soluble and/or water-dispersible polymer binder. Suitable binders are, for example, polyvinyl alcohol, completely or partially saponified, cationically modified polyvinyl alcohol, polyvinyl alcohol having silyl groups, polyvinyl alcohol having acetal groups, gelatine, polyvinyl pyrrolidone, starch, carboxymethyl cellulose, polyethylene glycol, styrene/butadiene latex and styrene/acrylate latex. The quantity of binder in the dye-fixing and ink-absorbing layer is respectively 5 to 35 wt. %, preferably 10 to 30 wt. %, relative to the weight of dried layer.

Both layers can contain usual additives and adjuvants such as tensides, cross-linking agents and dye-fixing agents.

The coating weights of the ink-absorbing and the dye-fixing layer can be 10 to 60 g/m², preferably 20 to 50 g/m².

Basically any raw paper can be used as support material. Surface-sized, calendered or non-calendered or strongly sized raw papers are preferred. The paper can be acidically or neutrally sized. The raw paper should have a high dimensional stability and should absorb the liquid contained in the ink without wave formation. Papers having high dimensional stability comprising pulp mixtures of soft wood pulp and eucalyptus pulp are especially suitable. In this respect, reference is made to the disclosure of EP 0 786 552 B1 which describes a raw paper for an ink-jet recording material. The raw paper can contain other adjuvants and additives common in the paper industry such as dyes, optical brighteners or defoamers. It is also possible to use waste pulp and processed waste paper. Raw papers having a basis weight of 50 to 300 g/m² can be used.

Especially suited as support material is paper coated on one side or on both sides with polyolefins, especially with polyethylene (LDPE and/or HDPE). The coating quantity of polyethylene is 5 to 20 g/m². Also polymer films, for example, comprising polyester or polyvinyl chloride are suitable as supports. The weight per unit area of support can be 50 to 300 g/m².

Any generally known coating and dosing methods such as roller application, engraving or nipping methods as well as air brushing or roll blade dosing can be used for depositing the layers. Especially preferred is coating using a cascade coating installation or a slot casting machine.

In order to adjust the curl behaviour, the antistatic property and the transportability in the printer, the back can be provided with a separate functional layer. Suitable back layers are described in EP 0 616 252 B1 and EP 0 697 620 B1 to which disclosure reference is made.

Now that the preferred embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

### EXAMPLES B1 to B3

A paper neutrally sized with alkyl ketene dimer and coated on both sides with polyethylene having a basis weight of 173 g/m² was used as the support for examples B1 to B3. The front of the raw paper was coated with a coating mass containing low-density polyethylene (LDPE) and 10 wt. % of TiO₂ and the back was coated with a clear LDPE by extrusion. The coating weight of the front-side coating was 19 g/m² and that of the back-side coating was 22 g/m².

The front of the support was coated with a coating mass containing 75 wt. % of a finely dispersed silica (300 nm) and 25 wt. % of a polyvinyl alcohol (degree of saponification 88 mol. %). Coating was carried out using a slot casting machine whereby an ink absorption layer was obtained. Onto this layer, whose coating weight in the dried state was 12 g/m², the coating mass for the dye-fixing layer was deposited using a slot casting machine. This coating mass contains 89 wt. % of a finely dispersed aluminium oxide (100 nm) and 11 wt. % of a polyvinyl alcohol (degree of saponification 88 mol. %). The coating weight was 30 g/m² in the dried state.

A protective layer was deposited on the dye-fixing layer as an aqueous solution in two working steps. In the first working step the copper compound (Examples 2 and 3) was deposited with the hydroxybenzoic sulphonic acid (Example 1). Boric acid and thiourea were then deposited in the second working step. The coating weight relates to the dried layer. The total coating weight of the protective layer in examples B1 to B3 was 3.2 g/m².

TABLE 1

| Compound | B1 (wt. %) | B2 (wt. %) | B3 (wt.%) |
|---|---|---|---|
| Boric acid | 50 | 50 | 40 |
| Thiourea | 37.5 | 40 | 40 |
| Copper(II)gluconate | 6.26 | 10 | — |
| Copper(II)EDTA | | — | 20 |
| 4-Hydroxybenzoic | 6.25 | — | — |
| sulphonic acid | | | |

### EXAMPLES B4 to B6

The support from Examples 1 to 3 was used for Examples B4 to B6.

The front of the support was coated with a coating mass containing 89 wt. % of a finely dispersed aluminium oxide (average particle size 100 nm; BET specific surface area 150-200 m²/g; zeta potential +30 to 40 mV) and 11 wt. % of a polyvinyl alcohol (degree of saponification 88 mol. %). The coating weight of this image recording layer was 38 g/m² in the dried state.

A protective layer was deposited on the image recording layer as an aqueous solution in two working steps. In the first working step the copper compound (Examples 5 and 6) was deposited with the hydroxybenzoic sulphonic acid (Example 4). Boric acid and thiourea were then deposited in the second working step. The weight information relates to the dried layer. The total coating weight of the protective layer in examples B4 to B6 was 3.2 g/m².

TABLE 2

| Compound | B4 (wt. %) | B5 (wt. %) | B6 (wt. %) |
|---|---|---|---|
| Boric acid | 50 | 50 | 40 |
| Thiourea | 37.5 | 40 | 40 |
| Copper(II) | 6.26 | 10 | — |
| gluconate | | | |
| Copper(II)EDTA | | — | 20 |
| 4-Hydroxybenzoic | 6.25 | — | — |
| sulphonic acid | | | |

### EXAMPLES B7 to B9

The support from Examples 1 to 3 was used for Examples B7 to B9.

A coating mass containing 89 wt. % of a finely dispersed aluminium oxide (100 nm) and 11 wt. % of a polyvinyl alcohol (degree of saponification 88 mol. %) was mixed with the copper compound specified in the table and 4-hydroxybenzoic sulphonic acid and deposited on the front of the support. The coating weight of this image recording layer was 38 g/m² in the dried state.

Boric acid and thiourea were deposited in a separate coating layer in the concentrations in accordance with Table 3. The coating weight of the protective layer was 2.7 g/m². The weight data refers to the dried layer.

TABLE 3

| Compound | B7 [g] | B8 [g] | B9 [g] |
|---|---|---|---|
| Boric acid | 1.5 | 1.5 | 1.35 |
| Thiourea | 1.2 | 1.2 | 1.35 |
| Copper(II) | 0.1 | 0.25 | — |
| gluconate | | | |
| Copper(II)EDTA | | — | 0.4 |
| 4-Hydroxybenzoic | 0.1 | — | — |
| sulphonic acid | | | |

### COMPARATIVE EXAMPLES

### Comparative Examples V1 to V3

A recording sheet as in Examples B1 to B3 was used and coated with the compounds specified in Table 4 from aqueous solution in one work step. The weight data refers to the dried layer. The coating weight for V1 to V3 was 1.8 g/m² in each case.

TABLE 4

| Compound | V1 wt. % | V2 wt. % | V3 wt. % |
|---|---|---|---|
| Boric acid | 80 | 100 | 60 |
| Thiourea | — | — | 40 |
| Copper(II) | 20 | — | — |
| gluconate | | | |

### Comparative Example 4

The support material from Examples B1 to B3 without the compounds according to the invention was used as comparative example 4.

### Comparative Example 5

A commercially available paper “Epson Premium Glossy Photo Paper” was used as comparative example 5.

### Comparative Example 6

A commercially available paper “Canon PR 101” was used as comparative example 6.

Testing

The recording materials obtained were tested for light fastness, ozone resistance and color gamut.

The basis for the tests were color prints from three different types of printer Epson Stylus 890 Photo Printer, Canon S800 Photo Printer and Hewlett-Pacckard 990 Printer. Circular dots having a diameter of 10 mm were printed for the colors cyan, magenta, yellow, black and red (color gamut). Printing took place at 23° C. at a relative humidity of 50%. The prints were allowed to dry for 8 hours under these conditions. The test results are summarised in Tables 5 to 7.

Ozone resistance—The printed paper samples were dried and stored for 24 hours excluded from the effects of light, gas and humidity. The calorimetric L*a*b* values of the Color area were then determined.

In the next step the samples were stored for 24 hours in an ozone chamber at an ozone concentration of 3.5 ppm, a temperature of 20 to 22° C. and a relative humidity of 40 to 50%. The L*a*b* values were then measured again and the degree of bleaching AE was determined.

The L*a*b* values were measured using an X-Rite Color Digital Swatchbook (X-Rite Inc., Grandville, Mich., USA). The Color shift ΔE is calculated using the equation: ΔE=[(AL*)²+(Δa*)²+(Δb*)²]^{1/2}. The bleaching of each color surface compared with the standard material is calculated as % ΔE in accordance with the following equation (DIN 6174): % ΔE=(ΔE/ΔE Standard)×100%. The smaller the % ΔE value, the better the ozone resistance of the material.

Light fastness—The paper samples were printed with the Color magenta in a color coverage of 40%, 60% and 80% and inserted for 48 hours at 30° C. and relative humidity of 60% in an Atlas 3000i Weatherometer (1.2 W/m²). The bleaching of the color was evaluated using the CIE L*a*b system.

The L*a*b* values were measured using an X-Rite Color Digital Swatchbook (X-Rite Inc., Grandville, Mich., USA). The color shift ΔE is calculated using the equation: ΔE=[(ΔL*)²+(Δa*)²+(Δb*)²]^{1/2}.

Color gamut—The color gamut was determined by means of a color determination of the values a* and b* for the Colors red and magenta using an X-Rite Color Digital Swatchbook (X-Rite Inc., Grandville, Michigan, USA). The color red consisted of 50 parts each of Epson yellow and Epson magenta.

The comparative example V4 was taken as the standard for this test since this material contains no compounds which could cause a color gamut. The closer the measured values of the examples and the comparative examples to V4, the lower the color gamut.

Light fastness (Epson 890 Printer)

| | ΔE (40%) | ΔE (60%) | ΔE (80%) | Total % ΔE |
|---|---|---|---|---|
| B1 | 11.21 | 10.22 | 14.22 | 35.65 |
| B2 | 11.29 | 10.78 | 14.55 | 36.62 |
| B3 | 9.70 | 7.36 | 14.88 | 31.94 |
| B4 | 11.42 | 10.35 | 14.55 | 36.32 |
| B5 | 11.49 | 10.87 | 14.68 | 37.04 |
| B6 | 9.90 | 7.69 | 15.01 | 32.60 |
| B7 | 11.47 | 10.41 | 14.50 | 36.38 |
| B8 | 11.58 | 11.02 | 14.66 | 37.26 |
| B9 | 10.04 | 7.65 | 14.96 | 32.65 |
| V1 | 10.83 | 12.83 | 13.11 | 36.77 |
| V2 | 16.66 | 23.35 | 17.63 | 57.65 |
| V3 | 20.62 | 32.22 | 30.34 | 83.18 |
| V4 | 14.68 | 15.77 | 11.93 | 42.39 |
| V5 | 13.29 | 19.41 | 19.02 | 51.72 |
| V6 | 15.70 | 21.58 | 19.71 | 56.99 |

TABLE 6
Ozone resistance
Total ΔE

| | Epson 890 | Canon S800 | HP 990cxi |
|---|---|---|---|
| B1 | 16 | 41 | 19 |
| B2 | 18 | 45 | 21 |
| B3 | 18 | 46 | 22 |
| B4 | 16 | 42 | 19 |
| B5 | 19 | 45 | 22 |
| B6 | 19 | 48 | 22 |
| B7 | 17 | 44 | 20 |
| B8 | 19 | 46 | 23 |
| B9 | 19 | 48 | 23 |
| V1 | 64 | 128 | 152 |
| V2 | 70 | 137 | 182 |
| V3 | 19 | 53 | 23 |
| V4 | 93 | 142 | 198 |
| V5 | 39 | — | — |
| V6 | — | 149 | — |

As can be seen from Tables 5 and 6, a significant improvement in the ozone resistance and good light fastness can be achieved by the compounds used according to the invention. Thiourea alone (V3) shows a good ozone reistance but has a disadvantageous influence on the light fastness of the magenta dye (Epson 40-80%) in microporous ink-jet recording materials. Boric acid alone (V2) has little influence on the ozone resistance of microporous recording material; however it improves the surface strength (scratch resistance) of the recording material since it cross links with the PVA and aluminium oxide of the layer. Copper(II)gluconate alone shows only a slight improvement in the ozone resistance but a significant improvement in the light fastness of the magenta dye. However, the color gamut is not acceptable; the colors show a visually detectable cloudiness. The samples according to the invention show a significant improvement in ozone resistance and light fastness. The results relating to the Color gamut in the red and magenta range are very good and an image with a natural and bright coloration is obtained.

TABLE 7
Color gamut
Epson Stylus 890 Photo Printer

| | Red | Red | Magenta | Magenta |
|---|---|---|---|---|
| | a* | b* | a* | b* |
| B1 | 71.11 | 42.19 | 80.49 | 4.08 |
| B2 | 71.07 | 42.10 | 80.45 | 4.08 |
| B3 | 71.21 | 42.22 | 80.59 | 4.11 |
| B4 | 71.58 | 41.99 | 80.87 | 4.18 |
| B5 | 71.55 | 41.91 | 80.85 | 4.15 |
| B6 | 71.60 | 41.91 | 80.99 | 4.18 |
| B7 | 71.49 | 42.05 | 80.61 | 4.14 |
| B8 | 71.45 | 42.11 | 80.57 | 4.12 |
| B9 | 71.57 | 42.01 | 80.69 | 4.16 |
| V1 | 65.50 | 36.39 | 77.22 | −1.47 |
| V2 | 72.46 | 44.63 | 81.67 | 4.69 |
| V3 | 71.46 | 41.85 | 80.93 | 4.33 |
| V4 | 72.22 | 41.65 | 81.42 | 4.32 |
| V5 | 67.94 | 38.48 | 79.64 | 4.49 |
| V6 | — | — | — | — |

We claim:

1. An ink jet recording material comprising a support and at least one image recording layer, wherein on the upper side of the image recording layer there is deposited a protective layer containing an organic sulphur-containing compound which forms complexes with metal ions and a boric acid compound and wherein the image recording layer and/or the protective layer contains an organic compound having the formula MeX or MeX₂ where Me is a transition metal from group VIb, VIIb, VIIIb, Ib and IIb in the Periodic Table and X is an anion of a carboxylic acid having 4 to 12 carbon atoms.

2. The recording material according to claim 1, wherein the image receiving layer contains at least one dye-fixing layer and at least one ink absorbing layer.

3. The recording material according to claim 1 wherein the transition metal is selected from the group consisting of copper, cobalt, nickel, and manganese.

4. The recording material according to claim 1 wherein the anion is an anion of a hydroxycarboxylic acid.

5. The recording material according to claim 4 wherein the hydroxycarboxylic acid is selected from gluconic acid, glucaric acid, succinic acid, hydroxysuccinic acid (malic acid), 2,3-dihydroxysuccinic acid (tartaric acid) and their mixtures.

6. The recording material according to claim 4 wherein the hydroxycarboxylic acid is selected from the group of compounds containing an aromatic ring, especially hydroxybenzoic acids such as 2-hydroxybenzoic acid (salicylic acid), 3-hydroxybenzoic acid, 4-hydroxybenzoic acid, 2,4,5-trihydroxybenzoic acid, 4- or 5-sulphosalicylic acid, 4- or 5-hydroxythiosalicylic acid.

7. The recording material according to claim 1 wherein the anion is selected from ethylene diamine tetracetic acid (EDTA), ethylene diamine triacetic acid, hydroxyethyl ethylene diamine tetracetic acid (HEEDTA), nitrolo triacetic acid or their salts.

8. The recording material according to claim 1 wherein the metal-compound-containing layer contains a hydroxybenzoic sulphonic acid as another component.

9. The recording material according to claim 1 wherein the complex-forming organic sulphur compound is a compound having the general formula R₂C═S, whereby R equally or independently of one another is hydrogen, an NH₂ group, an NHR¹ group, an NR¹₂ group, a methyl, ethyl, propyl, isopropyl group, a substituted or non-substituted aryl with 5 to 12 carbon atoms or alkoxy with 1 to 3 carbon atoms, or both groups R form an aromatic or non-aromatic ring with 5 or 6 carbon atoms which can contain nitrogen and/or sulphur as a heteroatom, wherein R¹ equally or independently of one another has the same meaning as R.

10. The recording material according to claim 1 wherein the complex-forming organic sulphur-containing compound is a compound having the general formula 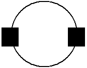
wherein Y denotes the atoms required to form a substituted or non-substituted aromatic or non-aromatic ring.

11. The recording material according to claims 1 to 8, wherein the complex-forming organic sulphur-containing compound is a compound having the general formula R₂S, wherein R equally or independently of one another denotes hydrogen, alkyl with 1 to 6 carbon atoms, substituted or non-substituted aryl with 5 to 12 carbon atoms, alkoxy with 1 to 3 carbon atoms, an NH₂ group, an NHR¹ group, an NR¹₂ group, OR¹, wherein R¹ has the same meaning as R.

12. The recording material according to claim 1 wherein the metal compound/sulphur-containing compound weight ratio is 1:1 to 1:2.
